(19) United States
(12) Patent Application Publication
(10) Pub. No.: US 2026/0341896 A1
(43) Pub. Date: Oct. 29, 2026

(54) VERTICAL DUAL LAYER ELECTRONIC VEHICLE BATTERY MODULE ENCLOSURE

(71) Applicants: FCA US LLC, Auburn Hills, MI (US); Stellantis Auto SAS, Poissy (FR)

(72) Inventor: Zachary E. Cook, Auburn Hills, MI (US)

(21) Appl. No.: 19/189,557

(22) Filed: Apr. 25, 2025

(51) Int. Cl. H01M 50/367; H01M 50/224; H01M 50/233; H01M 50/249; H01M 50/342; H01M 50/375

(52) U.S. Cl. CPC H01M 50/367; H01M 50/224; H01M 50/233; H01M 50/249; H01M 50/3425; H01M 50/375; H01M 2200/10; H01M 2200/20

(57) ABSTRACT

A battery module assembly for an electrified vehicle includes a unitary battery module, and a plurality of first battery cells. The unitary battery module enclosure includes a first enclosure portion having a first cell cavity and a first air cavity that defines a first thermal runway passage, the first cell cavity and the first air cavity separated by a first divider wall. The plurality of first battery cells are arranged in the first cell cavity. The first divider wall is configured to form a first opening caused by a thermal event that connects the first cell cavity to the first air cavity, wherein gas released from at least one of the first battery cells flows through the first opening, along the first thermal runway passage and out of the enclosure. The divider then effectively protects neighboring cells and prevents cell-to-cell thermal propagation.

### FIELD

The present application generally relates to electrified vehicles and, more particularly, to a battery module assembly having a battery module enclosure that integrates dedicated zones for gas venting.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The high voltage battery system generally includes a battery pack or module assembly that includes an enclosure that houses one or more battery modules. Thermal management of the battery module assembly is critical to optimize performance during the life of the vehicle. Some battery module assemblies are immersion cooled where the battery is submerged in a dielectric coolant, establishing direct contact between the coolant and the heat source. In some thermal runway events, gases can be released from the battery cells. It is desirable to efficiently manage such gases.

### SUMMARY

According to one example aspect of the invention, a battery module assembly for an electrified vehicle includes a unitary battery module, and a plurality of first battery cells. The unitary battery module enclosure includes a first enclosure portion having a first cell cavity and a first air cavity that defines a first thermal runway passage, the first cell cavity and the first air cavity separated by a first divider wall. The plurality of first battery cells are arranged in the first cell cavity. The first divider wall is configured to form a first opening caused by a thermal event that connects the first cell cavity to the first air cavity, wherein gas released from at least one of the first battery cells flows through the first opening, along the first thermal runway passage and out of the enclosure, thus separating the neighboring cells from the thermal runaway gases to prevent cell-to-cell thermal propagation.

In some implementations, the battery module assembly further comprises: a first end plate arranged at a first end of the enclosure, the first end plate defining a first relief passage; and a second end plate arranged at a second end of the enclosure, the second end plate defining a second relief passage. The gas released from the at least one of the first battery cells flows through the first opening, along the first thermal runway passage, through at least one of the first and second relief passages.

In some implementations, the first divider wall further comprises: lateral divider wall portions extending on opposite sides of vertical divider walls from a first central divider wall portion, wherein the lateral divider wall portions define a first thickness and the first central divider wall portion defines a second thickness, the second thickness being thinner than the first thickness.

In some implementations, the unitary battery module enclosure is formed of extruded aluminum.

In some implementations, the unitary battery module enclosure further comprises: a second cell cavity and a second air cavity that defines a second thermal runway passage, the second cell cavity and the second air cavity separated by a second divider wall, wherein the second cell cavity is arranged above the first air cavity; and a plurality of second battery cells arranged in the second cell cavity. The second divider wall is configured to form a second opening caused by a thermal event that connects the second cell cavity to the second air cavity, wherein gas released from at least one of the second battery cells flows through the second opening, along the second thermal runway passage and out of the enclosure.

In additional aspects, the battery module assembly further includes a first end plate arranged at a first end of the enclosure, the first end plate defining a first lower relief passage and a first upper relief passage; and a second end plate arranged at a second end of the enclosure, the second end plate defining a second lower relief passage and a second upper relief passage, wherein the first and second lower relief passages are fluidly connected to the first air cavity, and wherein the first and second upper relief passages are fluidly connected to the second air cavity.

In additional features, the second divider wall further comprises: lateral divider wall portions extending on opposite sides of vertical divider walls from a second central divider wall portion, wherein the lateral divider wall portions define a third thickness and the second central divider wall portion defines a fourth thickness, the fourth thickness being thinner than the third thickness.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery pack assembly according to various principles of the present application;

FIG. 2 is a top perspective view of a battery module assembly including an enclosure, a first end plate, a second end plate, and a plurality of battery cells, the battery module assembly configured as a dual layer assembly according to various principles of the present application;

FIG. 3 is a sectional view of the battery module assembly of FIG. 2 taken along lines 3-3 according to various principles of the present application;

FIG. 4 is a top perspective view of the battery module assembly of FIG. 2 shown with an opening formed in an upper divider wall of the enclosure allowing controlled gas release from a battery cell, through the opening, along an upper thermal runway passage in the enclosure, and out relief passages defined in the first and second end plates during a thermal runaway event according to various principles of the present application;

FIG. 5 is a top perspective view of a battery module assembly including an enclosure, a first end plate, a second end plate, and a plurality of battery cells, the battery module assembly configured as a single layer assembly according to various principles of the present application;

FIG. 6 is a sectional view of the battery module assembly of FIG. 5 taken along lines 6-6 according to various principles of the present application; and

FIG. 7 is a top perspective view of the battery module assembly of FIG. 5 shown with an opening formed in a divider wall of the enclosure allowing controlled gas release of battery cells through the opening, along a thermal runway passage in the enclosure, and out relief passages defined in the first and second end plates during a thermal runaway event according to various principles of the present application.

### DESCRIPTION

As discussed above, a high voltage battery system in an electrified vehicle generally includes a battery pack or module assembly that includes a housing that houses one or more battery modules. Thermal management of the battery module assembly is critical to optimize performance during the life of the vehicle. Some battery module assemblies are immersion cooled where the battery is submerged in a dielectric coolant, establishing direct contact between the coolant and the heat source. In some thermal runway events, gases can be released from the battery cells. It is desirable to efficiently manage such gases.

Some conventional battery modules include horizontally stacked battery cells with shared venting paths. Other conventional battery modules include vertical stacked module designs with limited structure or shared gas venting, allowing gases to mix freely during thermal events. In other arrangements, separate modules are stacked on top of one another, requiring additional structural components, busbars, and mounting systems which add complexity and weight. In some conventional arrangements, the enclosures are plastic without side impact, making them more vulnerable in collision scenarios. These prior art tall battery packs cannot utilize horizontal stacked battery cells optimally because there is no module enclosure which reduces energy density and increases the overall footprint of the battery module. Non-dedicated or shared venting designs increase the risk of gas mixing and thermal propagation (cell to cell and module to module gas thermal propagation). Separately stacked modules require additional components for structural support, busbar connections, and mounting leading to increased weight, complexity and installation time. Some existing module enclosures often do not include structural reinforcement for side impact protection, relying only on the battery pack structure during collisions.

The instant disclosure provides a battery module assembly that arranges two layers of cells in a vertical orientation into a single enclosure. The enclosure integrates dedicated zones (e.g., air cavities) for gas venting of the cells in case of thermal runaway, as well as features a robust enclosure structure that enhances side impact protection. The enclosure design ensures gases from each layer are managed independently, reducing the risk of propagation. The enclosure also simplifies pack integration by eliminating a module layer in current dual layer module pack designs, leading to streamlined assembly and service, and low voltage and high voltage (busbars) configurations.

The battery module enclosures disclosed herein solve the above problems found in conventional configurations. Dedicated cell venting zones are provided in the module enclosure for gas venting, preventing mixing of gases between layers and minimizing the risk of thermal propagation module to module and cell to cell. The battery module enclosures disclosed herein further provide enhanced structural integrity and side impact protection by integrating a robust metallic and/or composite enclosure structure that contributes to load transfer during collisions. Battery pack integration is simplified by eliminating a module layer from conventional dual layer module battery pack designs leading to streamlined assembly and service (module mounting) and optimized low voltage and high voltage (busbars) configurations. Utilizing a vertical stacked design with two layers of cells within a single enclosure maximizes energy density for tall battery packs while maintaining a compact footprint.

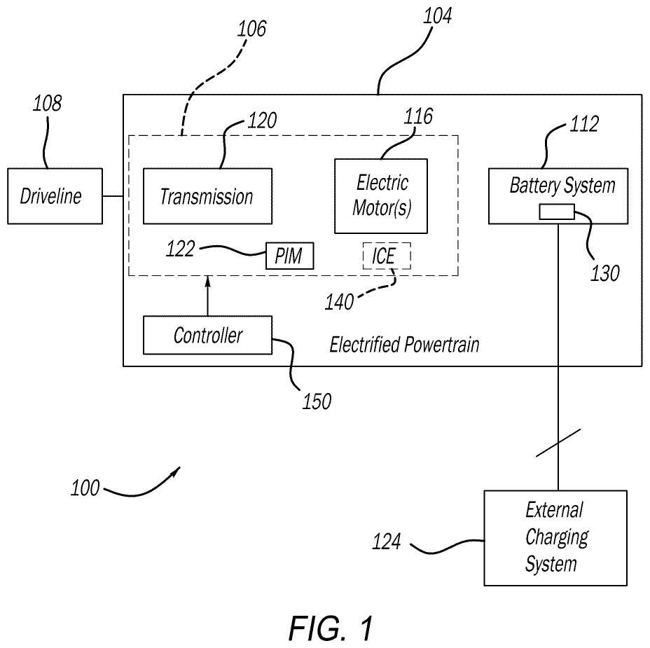

Referring now to FIG. 1, a functional block diagram of an example electrified vehicle 100 (also referred to herein as “vehicle 100”) according to the principles of the present application is illustrated. The vehicle 100 includes an electrified powertrain 104 having an electric drive module (EDM) 106 configured to generate and transfer drive torque to a driveline 108 for vehicle propulsion. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 124 to a high voltage battery system 112 for powering the electric motor 116. The battery system 112 is selectively connectable (e.g., by the driver) to an external charging system 124 (also referred to herein as “charger 124”) for charging of the battery system 112. The battery system 112 includes at least one battery pack assembly 130. In some examples, the electrified powertrain 104 can be a hybrid powertrain that additionally includes an internal combustion engine 140. A controller 150 can provide various inputs to the EDM 106 related to selectively switching power inputs between the electric motors 116 and the ICE 140.

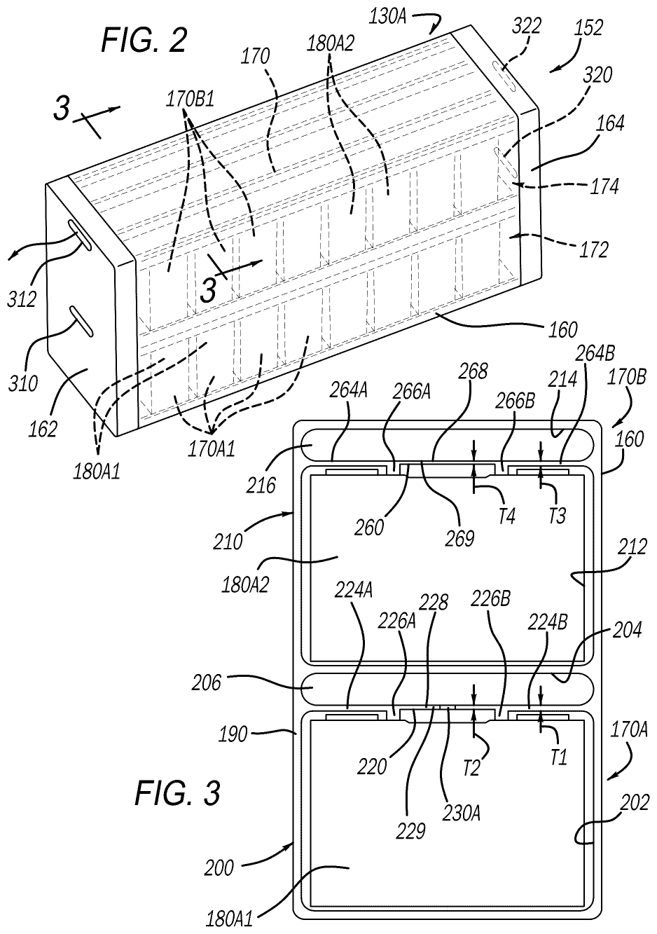

Turning now to FIGS. 2-4, a battery pack assembly 130A constructed in accordance to various examples of the present disclosure will be described. The battery pack assembly 130A generally includes a battery module assembly 152. The battery module assembly 152 includes an enclosure 160, a first end plate 162, and a second end plate 164. As will become appreciated from the following discussion, the battery pack assembly 130A can be adapted for immersive cooling applications. In immersive cooling, a cooling liquid surrounds all of the cells to provide a cooling effect. It will be appreciated however that the principles discussed can be also adapted for use with other cooling applications such as, but not limited to, cold plate and air cooling applications.

The battery module assembly 152 further comprises a plurality of battery modules, collectively identified at reference 170 and individually identified at reference numerals 170A1 and 170A2. In the example provided there are two layers 172 and 174 of battery modules 170. The first layer 172 is denoted by reference numerals 170A1. The second layer 174 is denoted by reference numerals 170A2. In the example shown, the first layer 172 is the lower layer while the second layer 174 is the upper layer. In examples, each battery module 170 includes a plurality of cells, collectively identified at 180. By way of example, and depending upon application, each battery module 170 can include many cells such as, but not limited to, 16, 20, 24 electrically connected cells. Other amounts of cells 180 may be incorporated in the battery modules 170 within the scope of this disclosure.

With particular reference now to FIG. 2, additional features of the battery module enclosure 160 will be further described. According to the present disclosure, the enclosure 160 is a single one-piece unit. In examples, the battery module enclosure 160 is formed of a rigid material such as, but not limited to, extruded aluminum. The battery module enclosure 160 generally includes an enclosure body 190 that defines a lower enclosure portion 200 and an upper enclosure portion 210. The lower enclosure portion 200 has a lower cell cavity 202 for receiving battery cells 180A1, and a lower air cavity 204 that defines a thermal runway passage 206. The upper enclosure portion 210 includes an upper enclosure portion 210 having an upper cell cavity 212 for receiving battery cells 180A2, and an upper air cavity 214 that defines an upper thermal runway passage 216.

The enclosure body 190 further includes a lower divider wall 220 formed between the lower cell cavity 202 and the lower air cavity 204. The lower divider wall 220 collectively includes lateral lower divider wall portions 224A, 224B extending on opposite sides of lower vertical divider walls 226A, 226B from a central lower divider wall portion 228. The lower divider wall 220 provides a lower separator sheet 229 at the central lower divider wall portion 228. In examples, the lateral lower divider wall portions 224A, 224B define a first thickness T1 and the central lower divider wall portion 228 defines a second thickness T2. The second thickness T2 is less than the first thickness T1. The reduced thickness T2 encourages an opening 230A to be formed (as a result of a thermal event) through the lower divider wall 220 at the separation sheet 229 of the central lower divider wall portion 228.

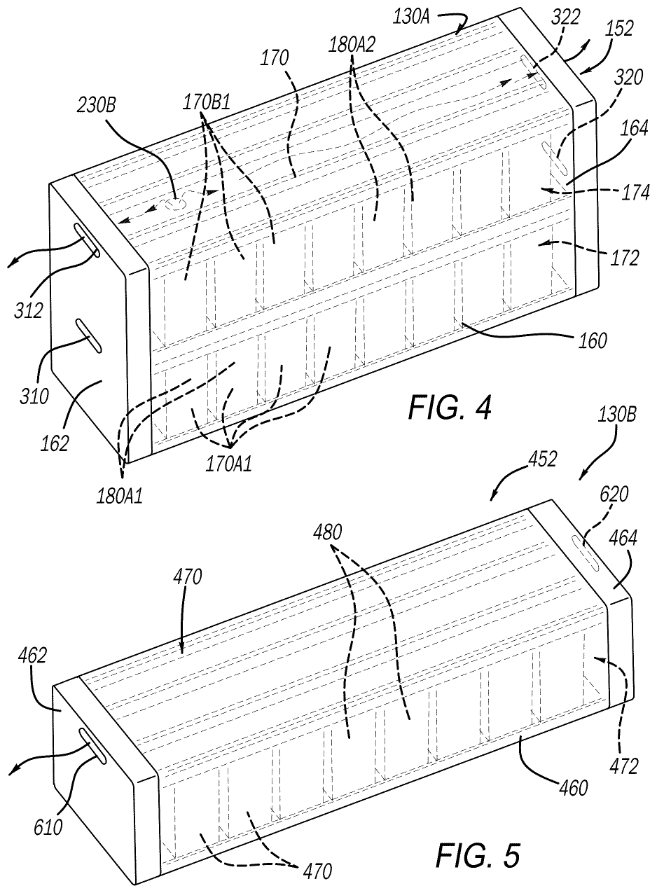

The enclosure body 190 further includes an upper divider wall 260 formed between the upper cell cavity 212 and the upper air cavity 214. The upper divider wall 260 collectively includes lateral upper divider wall portions 264A, 264B extending on opposite sides of upper vertical divider walls 266A, 266B from a central upper divider wall 268. The upper divider wall 260 provides an upper separator sheet 269 at the central upper divider wall portion 268. In examples, the lateral upper divider wall portions 264A, 264B define a third thickness T3 and the central upper divider wall portion 268 defines a fourth thickness T4. The fourth thickness T4 is less than the third thickness T3. The reduced thickness T4 encourages an opening 230B (FIG. 4) to be formed (as a result of a thermal event) through the upper divider wall 260 at the separation sheet 269 of the central upper divider wall 268.

Returning now to FIG. 2, the first end plate 162 defines a first lower relief passage 310 and a first upper relief passage 312. The second end plate 164 defines a second lower relief passage 320 and a second upper relief passage 322. As will become appreciated, the lower relief passages 310, 312 fluidly connect with the lower air cavity 204 and provide an outlet for gasses travelling through the lower thermal runway passage 206. Similarly, the upper relief passages 320, 322 fluidly connect with the upper air cavity 214 and provide an outlet for gasses travelling through the upper thermal runway passage 216.

Turning now to FIGS. 5-7, a battery pack assembly 130B constructed in accordance to various examples of the present disclosure will be described. The battery pack assembly 130B is constructed similarly to the battery pack assembly 130A described above, but only has a single layer of battery modules. The battery pack assembly 130B includes like components to the battery pack assembly 130A, but with reference numerals increased by 300. The battery pack assembly 130B generally includes a battery module assembly 452. The battery module assembly 452 includes an enclosure 460, a first end plate 462, and a second end plate 464. As will become appreciated from the following discussion, the battery pack assembly 130B can be adapted for immersive cooling applications. In immersive cooling, a cooling liquid surrounds all of the cells to provide a cooling effect. It will be appreciated however that the principles discussed can be also adapted for use with other cooling applications such as, but not limited to, cold plate and air cooling applications.

The battery module assembly 452 further comprises a plurality of battery modules, collectively identified at reference 470. In the example provided, there is one layer 472 of battery modules 470. In examples, each battery module 470 includes a plurality of cells, collectively identified at 480. By way of example, and depending upon application, each battery module 470 can include many cells such as, but not limited to, 16, 20, 24 electrically connected cells. Other amounts of cells 480 may be incorporated in the battery modules 470 within the scope of this disclosure.

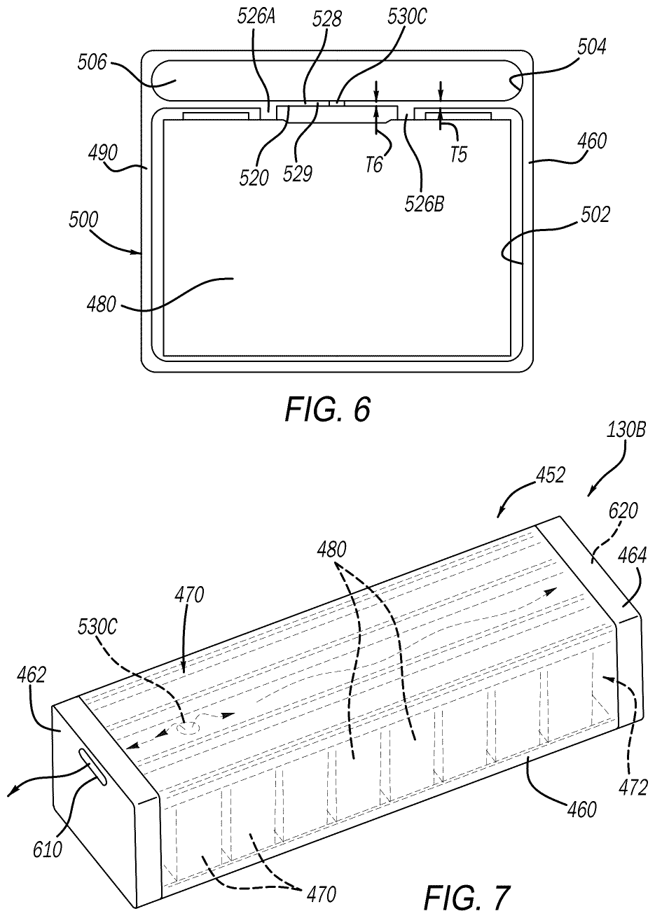

With particular reference now to FIG. 6, additional features of the battery module enclosure 460 will be further described. According to the present disclosure, the enclosure 460 is a single one-piece unit. In examples, the battery module enclosure 460 is formed of a rigid material such as, but not limited to, extruded aluminum. The battery module enclosure 460 generally includes an enclosure body 490 that defines a lower cell enclosure portion 500 having a cell cavity 502 for receiving battery cells 480, and an air cavity 504 that defines a thermal runway passage 506.

The enclosure body 490 further includes a divider wall 520 formed between the cell cavity 502 and the air cavity 504. The divider wall 520 collectively includes lateral lower divider wall portions 524A, 524B extending on opposite sides of lower vertical divider walls 526A, 526B from a central lower divider wall portion 528. The lower divider wall 520 provides a lower separator sheet 529 at the central lower divider wall portion 528. In examples, the lateral lower divider wall portions 524A, 524B define a first thickness T5 and the central lower divider wall portion 528 defines a second thickness T6. The second thickness T6 is less than the first thickness T5. The reduced thickness T6 encourages an opening 530C to be formed (as a result of a thermal event) through the lower divider wall 520 at the separation sheet 529 of the central lower divider wall portion 528.

Returning now to FIG. 7, the first end plate 462 defines a first relief passage 610. The second end plate 464 defines a second relief passage 620. The relief passages 610, 612 fluidly connect with the air cavity 504 and provide an outlet for gasses travelling through the thermal runway passage 506.

The battery module assemblies 152 and 452 described herein provide dedicated cell venting zones in the respective module enclosures 160 and 460 for gas venting, preventing the mixing of gases (such as between layers 172 and 174 in the stacked configuration of battery module assembly 152) and minimizing the risk of thermal propagation module to module. The battery module assemblies 152 and 452 further provide enhanced structure integrity and side impact protection by integrating a robust metallic/composite enclosure structure that contributes to load transfer during collisions.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A battery module assembly for an electrified vehicle, the battery module assembly comprising:
a unitary battery module enclosure comprising:
a first enclosure portion having a first cell cavity and a first air cavity that defines a first thermal runway passage, the first cell cavity and the first air cavity separated by a first divider wall; and
a plurality of first battery cells arranged in the first cell cavity;
wherein the first divider wall is configured to form a first opening caused by a thermal event that connects the first cell cavity to the first air cavity, wherein gas released from at least one of the first battery cells flows through the first opening, along the first thermal runway passage and out of the enclosure.

2. The battery module assembly of claim 1, further comprising:
a first end plate arranged at a first end of the enclosure, the first end plate defining a first relief passage; and
a second end plate arranged at a second end of the enclosure, the second end plate defining a second relief passage;
wherein the gas released from the at least one of the first battery cells flows through the first opening, along the first thermal runway passage, through at least one of the first and second relief passages.

3. The battery module assembly of claim 2, wherein the first divider wall further comprises:
lateral divider wall portions extending on opposite sides of vertical divider walls from a first central divider wall portion, wherein the lateral divider wall portions define a first thickness and the first central divider wall portion defines a second thickness, the second thickness being thinner than the first thickness.

4. The battery module assembly of claim 1, wherein the unitary battery module enclosure is formed of extruded aluminum.

5. The battery module assembly of claim 1, wherein the unitary battery module enclosure further comprises:
a second cell cavity and a second air cavity that defines a second thermal runway passage, the second cell cavity and the second air cavity separated by a second divider wall, wherein the second cell cavity is arranged above the first air cavity; and
a plurality of second battery cells arranged in the second cell cavity;
wherein the second divider wall is configured to form a second opening caused by a thermal event that connects the second cell cavity to the second air cavity, wherein gas released from at least one of the second battery cells flows through the second opening, along the second thermal runway passage and out of the enclosure.

6. The battery module assembly of claim 5, further comprising:
a first end plate arranged at a first end of the enclosure, the first end plate defining a first lower relief passage and a first upper relief passage; and
a second end plate arranged at a second end of the enclosure, the second end plate defining a second lower relief passage and a second upper relief passage, wherein the first and second lower relief passages are fluidly connected to the first air cavity, and wherein the first and second upper relief passages are fluidly connected to the second air cavity.

7. The battery module assembly of claim 6, wherein the second divider wall further comprises:
lateral divider wall portions extending on opposite sides of vertical divider walls from a second central divider wall portion, wherein the lateral divider wall portions define a third thickness and the second central divider wall portion defines a fourth thickness, the fourth thickness being thinner than the third thickness.

8. The battery module assembly of claim 7, wherein the unitary battery module enclosure is formed of extruded aluminum.
